(19) United States
(12) Patent Application Publication
(10) Pub. No.: US 2026/0166484 A1
(43) Pub. Date: Jun. 18, 2026

(54) GAS PROCESSING DEVICE

(71) Applicant: Scott Oliver GROSSMAN, Bushey (GB)

(72) Inventor: Scott Oliver GROSSMAN, Bushey (GB)

(73) Assignee: SO-G TECHNOLOGY LTD, Borehamwood (GB)

(21) Appl. No.: 19/103,196

(22) PCT Filed: Aug. 12, 2022
(86) PCT No.: PCT/GB2022/052106

§ 371 Date: Feb. 11, 2025

(51) Int. Cl. B01D 53/78; B01D 53/62; B01D 53/84

(52) U.S. Cl. CPC B01D 53/78; B01D 53/62; B01D 53/84; B01D 2251/95; B01D 2257/504; B01D 2259/4591

(57) ABSTRACT

The invention relates to a device for processing gas containing carbon dioxide comprising passing the gas through a tube filled with an algae material to capture the carbon dioxide and capture the carbon contained therein.

This invention relates to an apparatus and method for processing gases, in particular to capture carbon dioxide contained in the gases.

### BACKGROUND OF THE INVENTION

The increasing concentration of carbon dioxide in the atmosphere on both a local and a global level is major concern and its reduction is becoming a global priority. However, finding cost and energy effective ways of doing this without adding to the problem is a challenge. Existing carbon capture system often require large amounts of energy which can add to the carbon footprint of the process and reducing the effectiveness of the process.

### SUMMARY OF THE INVENTION

According to the present invention there is provided a carbon capture device comprising: a sump unit having a gas inlet and one or more gas outlets each provided on one surface; a plurality of tubes mounted on the sump unit, each said tube arranged to form a seal with said surface, the tubes arranged to include a respective gas inlet for providing gas to the interior of the tube.
This arrangement provides a low cost structure using standard tubes set into a sump unit which can be easily scaled up to different sizes and layout. This provides the potential to expand the range of products easily using the same technology and similar generic designs. The simplicity of the design helps to reduced number of components required and allows for simpler designs, meaning units which are easier and quicker to assemble and much cheaper than existing complex structures.
Preferably, the tubes have a hexagonal profile. This provides a convenient and efficient way to lay the tubes out efficiently. This ensures high space efficiency due to the hexagons joining up to form a compact design. The hexagonal tube shape allows each tube to butt up flush against each other, little or no space wasted between them. This is a significant advantage, especially for large scale bio-reactors where there may be several hundred tubes arranged compactly over a small surface area. The hexagonal layout with each face being arranged at 120 degrees relative to the next face means the light passes through the walls of each face of the tubes to carry light through the tubes to aid distribution of the light throughout the structure.
The device may further include a cover unit arranged at the other end of the tubes to the sump unit. The cover unit can include exhaust ports corresponding to respective tubes for allowing gas to escape from the tubes into the cover unit. This helps to prevent material falling into the otherwise open tubes and also allows control over fluid provided into the tubes as well as potentially controlling the level of fluid in the tubes to equalise across all tubes. It also allows control over the gas emerging from the top of the tube, particularly if the gas is to be captured either for use elsewhere or for sampling to monitor efficiency of the device.
The tubes are preferably arranged side by side in a linear pattern to form one of more layers of tubes. The one of more layers can form a continuous barrier similar to a fence panel. As the units are similar in design, they can be easily combined with others to form an extended barrier or fence. This component design allows for easy manufacture and installation as well as replacement where necessary. This also has the bonus of allowing easy access to all the internal components for maintenance and repairs.
As noted above, the tubes may be arranged with a plurality of layers of tubes, each layer including a plurality of tubes arranged side by side in a linear pattern, with adjacent layers closely interlocked with each other. This multi-layer structure provides a more substantial structure which may be useful where a simple single layer structure is not sufficient. For example, such multi-layer structure may be used where sound absorption is desirable. By providing multiple layers, improved sound absorption can be achieved which may be useful in places next to roads or railways, providing the multiple benefits of processing gas and providing a physical barrier which also reduces sound disturbance as well as visually masking the road/railway.
The multi-layer structure may have layers which are sandwiched between one or more layers restricting the light received directly. However, as noted above, the layout, particularly with hexagonal tubes, helps to distribute light from the outer layers into the inner layers of tubes. Furthermore, where light falls disproportionately on one side on the unit due to the orientation of the sun, light is carried through to the structure to even provide illumination to the layers on the opposite side.
The sump unit is preferably provided with a central recess for mounting around a post, with the tubes arranged around the central recess. This annular-type structure allows the unit to be mounted around other objects including at height such as the top of a lamp post, telegraph pole, CCTV camera post or other generally vertical structures. This allows easy installation onto existing infrastructure such as street furniture where the units are raised away from the ground, providing good access to light, removal form the pedestrian environment to avoid potential damage and without impacting or interfering with existing structures.
The sump unit is preferably formed in two or more separable parts to allow installation of the sump around a post positioned in the central recess. In this way, a two parts sump, for example, can be arranged around a lamp post with the lamp post passing through the recess defined by the two parts and then the parts attached together in situ. The tubes can then be arranged (or pre-arranged) so that the form a ring around the lamp post to maximise light collection form all directions.
The unit may have a gas supply for supplying gas to each of the gas outlets on the sump unit. The gas may be atmospheric air pumped into the sump or gas obtained from an industrial process piped to the unit.
The sump unit is preferably formed with a base unit on which the tubes are mounted and including the gas outlets, each of which is connected to a corresponding receiving port on the base unit; and a main body including interconnecting pipework for distributing gas to output ports on the main body, each corresponding to a receiving port, wherein the base unit and main body are separably connected to form the sump unit such that the output ports and receiving ports form a sealed connection between each other.
This simple modular structure allows the base units to accommodate the tubes and the main body to manage the distribution of gas and/or air. This modular structure allows for simpler manufacturing of the parts to accommodate variations of the design and so provide a cost effective way to produce many variations of the design.
The main body preferably further include two parts including a sump plate separably mounted to the sump unit, the sump plate enclosing the lower part of the sump unit to enclose the internal space of the sump unit. This means that the main body can be designed with an open arrangement to make formation of any channels for carrying fluid and gas or installation of any pipework much easier. The moan body is then sandwiched between the sump plate, sealing one side, and the base unit sealing the other.
The sump unit beneficially includes a fluid inlet corresponding to each of the tubes, for removing fluid from the tubes, each fluid inlet being connected to a fluid outlet on the sump unit for removing the fluid from the sump unit. This may be used to circulate the fluid or simply to allow filling and/or emptying of the tubes easily form the bottom.
The sump unit may include a surface or region defined by the region within the profile of an adjacent one of said tubes, the surface having a lower face and one or more side faces for directing fluid contained in the tubes into a respective fluid inlet of the sump unit. These faces effectively form the base of the bottom of the column of fluid within the tube. The arrangement helps to ensure efficient access of the gas to the tubes but also removal of the fluid and any solid material that may build up within the tube rather than remaining at the bottom of the tubes and potentially interfering with gas and fluid movement.
The lower face is preferably angled relative to the horizontal axis of the sump unit. This provides a form or ramp directing the flow of the fluid towards the drain point.
The side faces may also be angled relative to the vertical axis of the sump unit. This again helps to form ramped sides to aid directing the fluid flow towards to drain point without collecting in any crevices or regions at the bottom of the tubes.
The side faces may be flat but preferably have a concave profile forming a fillet shape. This again avoids sudden changes in surface angle and aims to provide smooth flow of the fluid.

### BRIEF DESCRIPTION OF THE DRAWINGS

Examples of the invention will now be described in more detail with reference to the accompanying drawings in which:

FIG. 1 shows a first embodiment of the invention;

FIG. 2 shows a schematic exploded view the first embodiment;

FIG. 3 shows a top view of the sump unit of the first embodiment;

FIG. 4 shows an enlarged partial view of the sump unit;

FIG. 5 shows a partial cut away view of one of the cells in the sump unit;

FIG. 6 shows a schematic view of the sump unit and lower part of the tubes;

FIG. 7 shows a view from below of the base unit;

FIG. 8 shows the view of the cover unit from below;

FIG. 9 shows a partial perspective view of the cover unit;

FIG. 10 shows a side view of a second embodiment of the invention in situ on a lamp post;

FIG. 11 shows a top view of the base of the second embodiment;

FIG. 12 shows a view from below of the base of the second embodiment;

FIG. 13 shows a modified two-part base of the second embodiment;

FIG. 14 shows a perspective view of the second embodiment of the invention

FIG. 15 shows a top view of the sump unit of a third embodiment;

FIG. 16 shows an angled top view of the sump unit of a third embodiment;

FIG. 17 shows a view from below of the main body of the third embodiment;

FIG. 18 shows the sump unit of a fourth embodiment with multiple layers of tubes;

FIG. 19 shows a partial enlarged view of the fourth embodiment;

FIG. 20 shows a partial perspective view of the fourth embodiment;

FIG. 21 shows a view of the underside of the cover unit of the fourth embodiment;

FIG. 22 shows a side view of the fourth embodiment;

FIG. 23A shows schematically the transfer of light within the walls of the tubes;

FIG. 23B shows a close up schematic view of light within the walls of the tubes;

FIGS. 24 to 26 show exemplary layouts of tubes;

FIGS. 27 to 29 show exemplary layouts of multiple layer tubes;

FIG. 30 shows schematically the path of a light ray through a square tube device; and

FIG. 31 shows schematically the path of a light ray through a triangular tube device.

### DETAILED DESCRIPTION

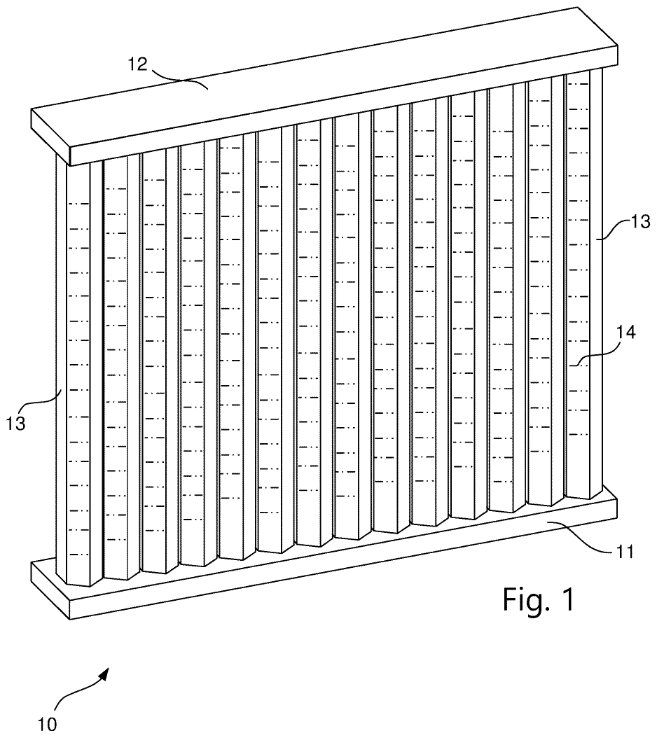

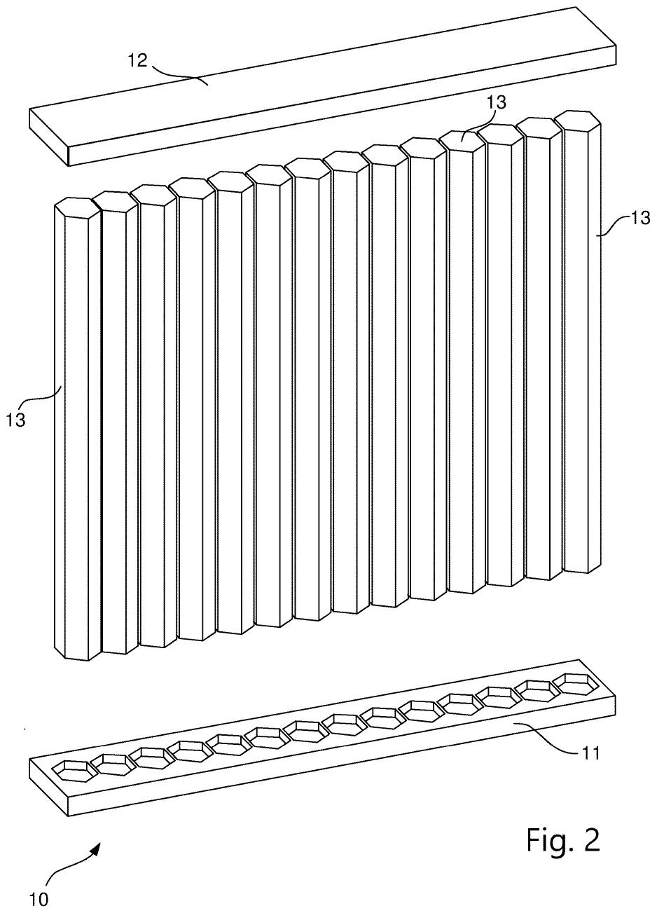

FIG. 1 shows a first arrangement of a carbon capture device 10. In this arrangement, a sump unit 11 is provided which provides the base of the device 10. Into this are inserted a plurality of tubes 13. Set above the tubes is a cover unit 12. FIG. 2 shows a schematic exploded view of the device 10.

The tubes 13 are open ended with their lower ends received into the sump unit 11 and a seal formed between the lower end of the tube and the sump unit. The tubes 13 are made of a material to facilitate light particularly ultraviolet light entering the interior. They are arranged in a linear pattern along the generally elongate sump unit 11. In this embodiment, the tubes 13 have a hexagonal cross section with one face of a tube arranged adjacent a face of the adjacent tube so that the tubes are closely packed with each other. The faces may be in contact or separated by a small gap to facilitate insertion and removal of tubes.

The hexagonal shape of the tubes 13 allows an efficient and compact design as the hexagonal tubes are able to butt up flush against each other to avoid leaving wasted space between them. This is particularly advantageous especially for large-scale bio-reactors where there may be over 300 tubes arranged over a small surface area. This may be in a clustered format where the individual tubes may be arranged in a honeycomb type arrangement allowing a compact design whilst still providing advantages over a single large tube. For example, some rows or positions within the structure may be left vacant or empty to aid in light distribution.

The hexagonal shape is also beneficial in terms of light refraction within the system, allowing the light to pass/refract between them freely with little loss of energy as it passes through the walls. Other polygonal shapes, particular close fitting ones can also provide similar advantages. For example, octagonal tubes may be used even though this would leave spaces, e.g. squares, between the tubes but this may aid in the light distribution.

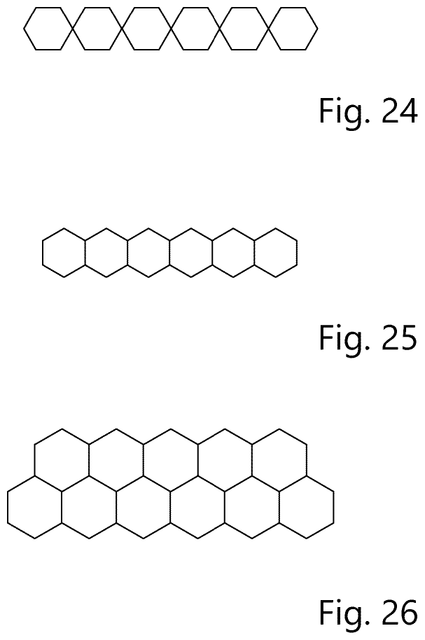

In an alternative arrangement, the edges of the tubes may be arranged adjacent to each other, as shown in FIG. 24, so that three sides of the tube (as opposed to two sides in the FIG. 1 arrangement, as also shown in FIG. 25) face generally away from one side of the unit whilst the other three sides face generally away from the other side i.e. rather than faces of adjacent tubes being opposed to each other, respective edges of the tubes are. In other words all six sides of the tubes are able to receive light directly. This may be useful in capturing light in certain directions depending on the orientation of the device 10.

In other arrangements, the tubes may be arranged with the centres of alternate tubes offset from the central axis of the device with the face of one tube adjacent the face of the adjacent tube—see FIG. 26. This allows more tubes to be fitted into a given length of the device 10. Other arrangements of tubes may be used according to specific circumstances and location of the device.

The cover unit 12 is provided above the tubes 13. The cover unit 12 includes recesses on the lower side to receive the upper ends of the tubes 13. Once in place, the cover unit 12 is engaged with the tubes to prevent the tube easily sliding off the top of the device. The upper part of the tube may be sealed against the cover unit 12, although this is not essential. However, by forming a seal, close monitoring of the gases can be conducted. Where multiple units are deployed such as along a long boundary, monitoring may be achieved using a batch sampling process, for example one in ten of the units may be sealed at the top and have sensors for monitoring that unit and the data collected form that unit being used as a proxy for the other units may be unsealed and open to the atmosphere.

In use, the tubes 13 are filled with a fluid 14. The fluid 14 includes a liquid suspension including algae. Microalgae contain pigment, chlorophyll, which enables the cell to perform oxygenic photosynthesis similar to that carried out in leaves. Chlorophyll can split water into oxygen and protons, thus releasing electrons during photolysis. The electrons that are released are used in photosynthetic electron-transfer reactions. The carbon fixation of microalgae utilises products from electron-transfer reactions such as ATP (adenosine triphosphate) and NADPH (nicotine adenine dinucleotide phosphoric acid), needed for the conversion of carbon dioxide (CO₂) to organic biomolecules.

A supply of gas (typically air) containing CO₂ is provided to the lower ends of the tubes via the sump unit 11. The natural buoyancy of the gas causes it to rise through the fluid 14 in the inner part of the tubes 13 passing through the algae. In this way, light falling on the algae in the tubes is provided with a ready supply of CO₂ to allow the conversion process to take place. Oxygen produced then rises up the tube towards the cover unit 12. I this way, the carbon in the CO₂ is captured by the algae and removed for the gas supplied.

As the algae absorbs the CO₂, the fluid progressively thickens and becomes more and more viscous as the algae grows and multiplies. Eventually, the fluid in the tube can be replaced, either completely or by removing some of the fluid and diluting the remainder. The fluid is drained out the bottom of the device, as explained below, and collected in a fixed storage tank or a portable container such as a tanker truck to transport it to the processing facility. The products in this extracted fluid contain organic materials that can be processed into valuable substances such as: fertiliser, biofuel, spirulina and other supplements, plastics, building materials etc. This provides a high value product from the processed algae rather than a waste product that needs to be disposed of. This value helps to reinforce the overall value of the process and reduce the environmental impact by offsetting products that would otherwise be used and often require resource intensive production, such as fertiliser.

The device is primarily operated using sunlight to allow the reaction to proceed and so the device is preferably placed in a location where adequate access to sunlight is provided. The linear arrangement of the device helps to maximise the light captured and the devices may be laid out in groups to provide other functions. For example, several of the devices may be arranged end to end to form a fence or other boundary divider. In this way, the devices require little or no additional ground space and provide a useful function of providing a boundary avoiding the need for any other boundary fence.

In some situations, the device may not be able to obtain sufficient natural sunlight and so supplementary light (primarily ultraviolet light to aid photosynthesis) may be provided by lighting units arranged to illuminate the tubes 13. With this artificial illumination, the devices can work in any location and may even be used indoors in a controlled environment, potentially all the time. The algae typically need a period of time when they are not photosynthesising and so the amount of time that the photosynthesis is allowed to occur can be controlled using the supplementary lighting. For example, it may be optimal to have 20 hours when photosynthesis is occurring and 4 hours without. The amount of daylight may vary from relatively few hours during the short hours of winter to much longer days during summer and so the need for supplementary light may vary around the year to optimise the efficiency of the device.

When the algae is not photosynthesising natural respiration will tend to occur and the algae will actually consume Oxygen. The gas supply may therefore be arranged to modify the gas supplied to include oxygen, at least in the periods when photosynthesis is not occurring. Where air is normally supplied then supplementary oxygen would not be required as the air naturally includes sufficient oxygen but in situations, then a purer CO₂ is used, such supplementing may be required, perhaps using atmospheric air.

The CO₂ containing gas provided to the tubes 13 may be derived from multiple sources. It may be simply obtained from the air around the device to reduce the carbon content of that air. However, it may be obtained as a by-product of some industrial process such as combustion of fossil fuels from a power station or some other industrial activity producing CO₂. In this way, CO₂ rich air can be processed to capture the carbon in the by-product to mitigate the carbon output by that process.

The gas provided to the device is pumped into the sump unit 11 and distributed to the base of each of the tubes 13 to then float up the tubes to be processed by the algae. At the top of the tubes, some or all of the CO₂ will have been absorbed and Oxygen will have been produced. The resulting mix of any residual CO₂, Oxygen produced and any other unprocessed components of the gas, e.g. Nitrogen in the case of air, will collect at the top of the tubes and pass into the cover unit 12. The cover unit gathers this and exhausts either directly into the atmosphere or into some further processing or storage device.

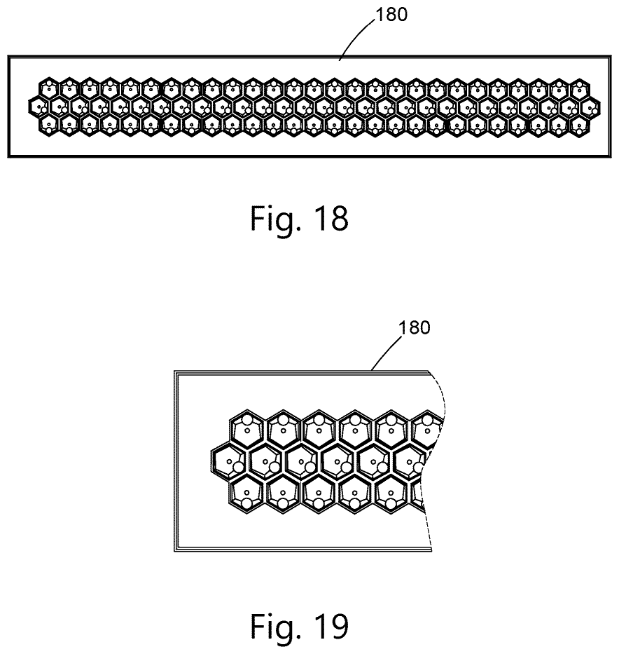

In FIGS. 1 and 2, the tubes are arranged in a single layer along the length of the device 10 to form a continuous panel. However, the tubes may be arranged in multiple layers in some arrangements. For example, in an alternative arrangement 140 as shown in FIGS. 17 and 18, the tubes may be arranged in 3 layers arranged using the hexagonal shape of the individual tubes to tightly pack them so that the inner faces of the tubes are in close or direct contact with the adjacent layer of tubes. Although this means that the middle layer is sandwiched between the two outer layers, light can still propagate through the outer tubes to impinge on the fluid in the middle layer. This maximises the use of the light falling on the tubes, as light not absorbed by the outer layer of tubes will pass into the central layer which will capture more of the light with any residual light captured in subsequent layers.

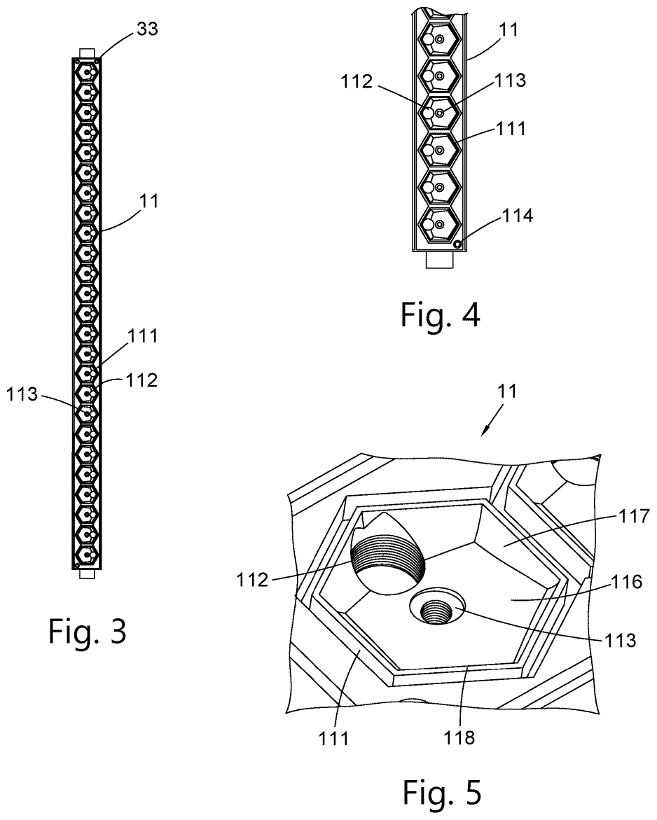

FIGS. 3 to 5 show more detailed views of the sump unit 11. FIGS. 3, 4 and 5 show cells for receiving the tubes which include the receiving channels 111 corresponding to each of the hexagonal tubes. The channels are also hexagonally shaped to receive the ends of the tubes 13 into the recessed channel 111 in the body of the sump unit 11. In this embodiment, the tubes are hexagonal but where the tubes have a different shape, the receiving channels 111 would be shaped accordingly. Each of the tubes 13 are inserted into the respective receiving channels 111 and a liquid-and air-tight seal is formed between them. The seal may be formed simply by inserting the tubes due to the materials being configured to form a seal such as by having a resilient material forming the surface of the receiving channel 111 or the surface of the tube 13. Alternatively a seal may be formed after insertion of the tube 13 by applying a sealing material, or gasket etc.

As can be seen from the enlarged partial view of FIG. 5, the receiving channel 111 has an inner wall 118 defining the inner part of the channel 111. Within the inner wall a base is provided on which the column of fluid in the tube rests. The base includes a number of faces including a lower face 116 and one or more side faces 117. The side faces 117 are angled (typically around 45 degrees) from the top of the inner wall down to the lower face 116 preferably with a concave or filleted shape to avoid any corners or edges that may encourage build-up of material, such that any material such as the algae dropping down the tube is directed towards and along the lower face 116.

The lower face 116 is angled relative to the axis of the sump unit 11, i.e. it is not perpendicular to the tube 13, which is generally perpendicular to the sump unit 11. Instead, the lower face 116 is sloped down towards an exit hole 112 at the bottom of the column of fluid. In this embodiment, the lower face 116 has an approximate gradient of 20% e.g. a fall of 9 mm over a length of 45 mm. However, the angle may be varied depending on the configuration of the tubes (height, width etc.) and the algae material, as the viscosity will vary with the algae used and over the lifecycle of the algae in the device. So, depending on how long the algae is in the tube and also other factors like air flow and light intensity will affect the viscosity and what the optimum angle is. Preferably the lower face has a gradient of between 2% and 20%.

The lower face 116 is planar in this arrangement but may have a concave or convex shape to facilitate the passage of the algae containing fluid into the exit hole 112.

An air stone is usually provided to aid in distributing the gases fed into the tube. This is typically a cylindrical shape positioned above the feed hole 113, and protrudes above the lower face 116 by around 2.5-5 cm. By protruding above the lower face 116 and having the lower face 116 angled the flow of air bubbles can be improved. In addition, this shape will help the air bubbles dislodge and prevent build-up of algae on the lower face 116.

The angled or chamfered side faces 117 and lower face 116 help prevent the build-up of algae which may obstruct the exit hole 112 rather than the algae flowing smoothly out when the time comes to empty the tubes. These angles or chamfers flow in the direction of the fluid hole.

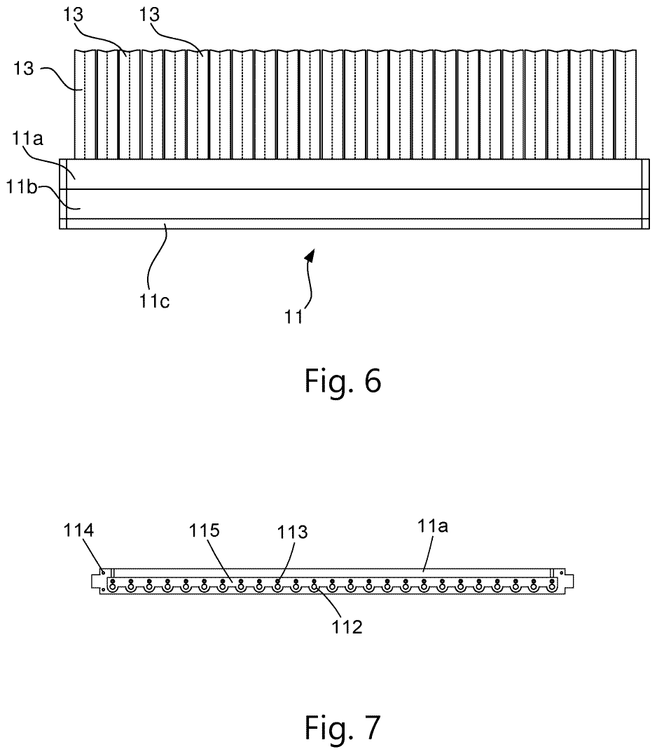

A gas feed hole 113 is provided at the bottom of the column of liquid. As shown in FIG. 6, this is provided in the lower face 116. The gas to be passed through the column of fluid is fed from the sump unit 11 via the feed hole 113 into the fluid, where it rises up through the column of fluid. This may be connected to an air stone or the like to aid distribution of the gas into the fluid.

In the arrangement of FIG. 1, the ends of the tubes are received into recesses 111 in the sump unit 11. However, the sump unit may include annular projections similar to the walls 118 but raised above the surface. These would have a profile corresponding to the inner or outer surface profile of the tubes, onto which the tubes are pushed to form a seal between the annular projections and the tubes.

The sump unit 11 is shown from the side in FIG. 6. The sump unit 11 is formed from three elements 11a, 11b, 11c. The sump plate 11c forms the bottom of the sump unit 11 and closes the bottom of the sump unit. This is essentially a plate structure which acts as a base and forms a closure for the elements above.

Above the sump plate 11c, is a sump body 11b which contains the functional parts of the sump unit including pipework for the exiting liquid, tubing for the air inlets to the air stones, wiring and solenoid valves (not shown). The piping connects the gas supply pipes in the sump unit 11 to each of the gas feed holes 113. Additional piping connects the exit holes 112 to an extraction port from the sump unit 11 for removal of the fluid (algae etc.) from the tubes. The solenoids are controlled by suitable controllers to control the removal of fluid from the tubes.

The sump plate 11c and sump body 11b may be formed as a single unit, i.e. a sump body with a permanently closed lower part formed as a single element. Alternatively, in other arrangements the sump plate 11c may be provided a panel on the side of the sump body 11b.

The piping integrated into the sump body 11b allows for the sump unit to have reduced height thereby allowing more of the available height to be used for the tubes and therefore the amount of light captured and algae and CO₂ processed. The height of the installation, e.g. where it is a fence may be limited by practical or administrative constraints, e.g. there may be a height limit before permission from local authorities is required. This helps to maximise the efficiency in the height available. This also has the added benefit of decreasing costs in the long term by avoiding the use of fittings that would not only be bulky but also not designed specifically for the unit and therefore costly.

The upper element of the sump unit is the base unit 11a which is provided above the sump body 11b and includes the features shown in FIGS. 3 to 5, including the hexagonal receiving channels 111, exit hole 112, feed hole 113, lower face 116, side faces 117, inner wall 118 and the fluid exit connectors (not shown). It also receives the air stones and the bottom of the tubes 13.

The three elements of the sump unit 11 are attached to each other to form the complete sump unit. Each unit includes a plurality of holes 114 aligned in each elements and through which a retaining member such as a threaded bolt (not shown) is passed through to attach the elements to each other. In this embodiment, pipework and tubing is provided in the sump unit 11 for supplying and containing the liquid and gas respectively and so additional sealing between the elements 11a, 11b, 11c of the sump unit 11 are not essential. A seal will need to be formed between the bottom of the tubes 13 and the sump unit 11 to prevent fluid within the tubes leaking. In other embodiments, the elements 11a, 11b, 11c of the sump unit 11 may be sealed together to avoid the need for separate pipework/tubing for the liquid/gas. Piping and channels formed as part of the structure of the sump unit can then be used to carry and contain the liquid/gas and minimise any additional pipework needed.

FIG. 7 shows a view of the underside of the base unit 11a where the exit hole 112 and feed hole 113 emerge from the lower part of the base unit 11a. These are then connected to the piping in the sump unit 11b. A recess 115 provides space to house the components that screw into exit holes 112 and feed holes 113.

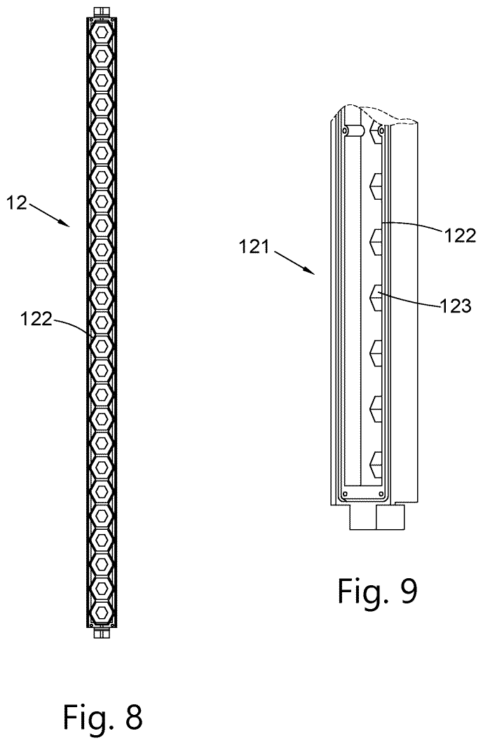

FIG. 8 shows the lower surface of the cover unit 12. The cover unit 12 includes recesses 122 similar to those on the base unit 11a of the sump unit 11. These recesses 122 are shaped to match the profile of the tubes 13, in this case hexagonal, so that the top ends of the tubes can be received into the recesses.

The cover unit 12 is also formed in a multi-element laminar type structure. In this case, it is formed from two parts. The lower part is a cover body member 121. FIG. 9 shows the cover body member 121 from above which includes the channels 123 passing through to the bottom of the cover body member 121 where the recesses for receiving the top of the tubes is located. The passages 123 passing through the body member 121 allow the passage of gasses emitted from the top of the fluid in the tubes 13 to escape as well to allow fluid to be introduced from above. By filling from above, the tubes are progressively filled until each is full, with any additional fluid overflowing into the next tube ensuring complete filling of all the tubes.

The cover body member 121 also includes a plenum like space for the gasses exiting the tubes to pass into pipework to carry them away either to exhaust into the atmosphere or to a separate until for storage or processing. The cover body member 121 may also include additional pipework for carrying the fluid into the tubes for initial filling and refilling. The pipework may be formed from the structure of the body rather than having pipework added to it, as with the sump unit.

Above the cover body member 121 is a closure lid (not shown) similar to the sump plate 11c which provides a top to the unit and encloses the components (pipework etc.) within the cover body member 121. Again, the two are attached together to form the complete cover unit 12. The closure lid can be removed to allow for easy access for inspection, or substituted with a maintenance top plate to allow for testing and for maintenance purposes. The laminar structure provides flexibility in the design and ease of construction using the modular elements. The elements can easily be scaled up or down for different applications and to provide additional functionality. For example, the closure lid for the cover unit 12 may be replaced to allow for future modifications and improvement such as providing a fluid storage container on the top to increase maintenance intervals. Other modifications may be envisaged such as a solar panel, a wind turbine, advertisement space, a filler mechanism, a testing module and so on.

The modular design also allows for different applications. In the embodiment above, the application is a fence panel or boundary feature, but may be modified for other applications, which is facilitated by the modular design described above. The similarly designed layers allow for easy component design and replacement where necessary with the advantage of allowing easy access to all the internal components for maintenance and repairs.

In use, the sump unit 11, tubes and cover unit 12 can be constructed on site. The tubes are then filled with the algae containing fluid, in this case via the cover unit 12 (but optionally from below via the sump unit). The unit is then activated so that the CO2 containing gas is pumped into the sump unit and released into the bottom of the tubes 13 via the gas feed holes 113. Depending on the source of the gas, the unit may include a simple air pump, for example where atmospheric air is used, or the supply may be obtained, possibly under pressure, from another source such as the exhaust from some combustion process.

The pumps, control systems and any supplementary lighting can be powered from integrated solar panels or wind turbines. Larger facilities with multiple units may have a centralised power source such as a dedicated solar array or grid power, ideally sourced from renewable sources. Again grid power offset by retiring carbon credits can be used to compensate for electricity production pollution.

The carbon capture device 10 can then be left running, processing the gases passing through it whilst the algae develops. Eventually, once the algae has reached a certain concentration and/or the viscosity of the fluid has reached an optimal value, the fluid in the tubes is treated, either by draining the tubes completely or partially and then replacing the fluid with fresh fluid. The cycle can then be repeated. The criteria for determining when to refresh the fluid will depend on a number of factors. One of these will be a particular decrease in the rate of absorption of CO₂. The point at which this becomes necessary will depend on how efficient the processing needs to be. If removal of all the CO2 is required then refreshing of the liquid may be required more often whereas if a lower efficiency can be tolerated, then replacement can be deferred for longer. The viscosity of the fluid must also be considered as this may affect the ability to drain the device without clogging the pipework.

In the above, it is intended to refresh the tube periodically in a batch like process. However, the fluid may be constantly fed through the tubes. The fluid removed may be filtered to remove some of the algae to maintain the concentration at a desired level. The system may include a separate sump or chamber for storing and processing the fluid not in the tubes.

The fluid removed is rich in nutrients from the algae which has grown in it and can be used in various applications such as fertilisers, food and other products, to offset similar products that might be produced from carbon intensive processes. The products removed can also be used to create plastics from the carbon rich algae which will help to offset other more harmful plastics typically produced using fossil fuels whilst also permanently capturing the CO₂ unlike fertilisers, food etc. which would tend release it back into the atmosphere.

This means that apart from periodic replacement of the fluid, the device can be left running with little or no maintenance and provides a low-cost solution to removal of CO₂ from air or other gases.

The above embodiment provides a linear structure for use as a divider or fence. However other structures may be suitable for different applications. In an urban environment, particularly around roads where there is a CO₂ rich environment due to vehicles and burning of fossil fuels for heating etc, it may be desirable to have carbon capture devices. However, the linear design may not be suitable as there may be inadequate space with sufficient light to maximise the efficiency of such units. However, where there are roads there tends to be street furniture and in particular lamp posts. These provide a good, elevated position for carbon capture devices. By mounting them on lamp posts or other posts such as telegraph posts, they can be raised above pedestrian height whilst also getting good access to light and the CO₂ rich air around the road.

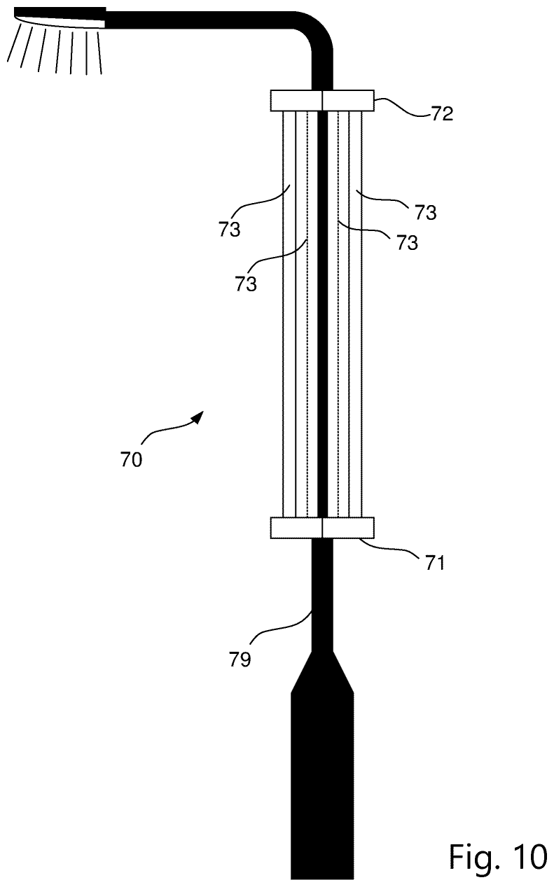

FIG. 10 shows an example of a carbon capture device 70 suitable for mounting on a lamp post 79 as shown, or other similar structure. Rather than a linear structure, the tubes 73 are arranged generally concentrically around the lamp post 79. In this way, the light incident on it can be captured from all directions whilst maintaining a relatively low profile, which is advantageous both in terms of the structural aspects such as managing wind load, but also avoiding creating obstructions, especially if the lamp post is close to a road where protruding too far from the lamp post may represent a collision hazard for passing vehicles. The low profile also provides a more aesthetic structure than a large panel like device such as that in FIG. 1.

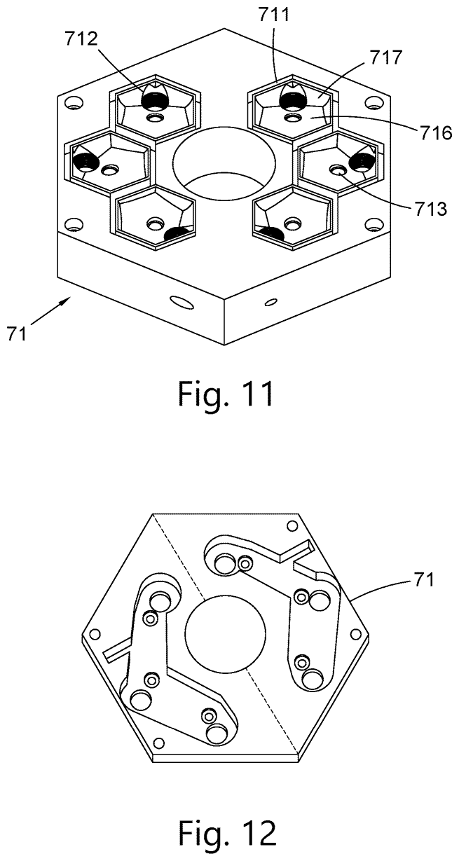

The basic cellular structure is similar to the arrangement shown in FIG. 1 in that it includes a sump unit 71, cover unit 72 and a plurality of tubes 73 arranged between them. The sump unit 73 has a similar laminar or multi-element structure to that shown in FIG. 6, although this is not shown in the Figures. FIG. 11 shows an enlarged view of the sump unit 71 from above and FIG. 12, shows the same from below. The sump unit 71 includes a plurality of recesses on its surface although as stated above, they are arranged in a generally concentric arrangement around a central annular recess which is arranged around the upright part of the lamp post.

The device 70 shown in FIG. 11 is generally hexagonal in section although this is not essential and other shapes are possible to accommodate the recesses into which the tubes 73 are inserted. The cells and recesses have a similar structure to those in FIG. 5. A receiving channel 711 is provided into which the corresponding hexagonal tube 73 can be inserted. An exit hole 712 is also provided, as well as a gas feed hole 713 to provide an inlet for the gases passed through the tube 73. The lower face 716 is similarly angled and may also be slightly concave to aid flow of the algae into the exit hole 712. Around the lower face are one or more side faces 717 angles up towards the bottom of the tube 73.

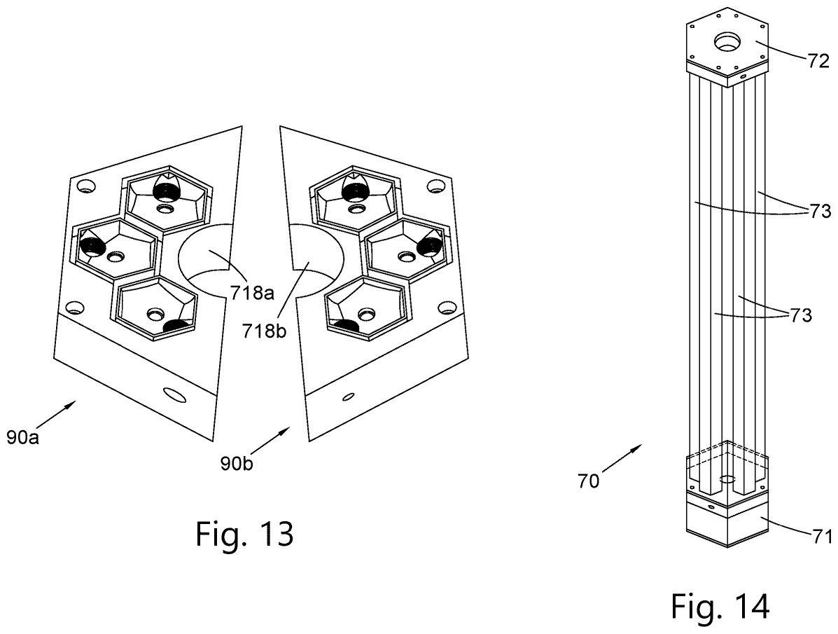

FIG. 13 shows a variant of the sump unit 71 which is provided in two parts 90a, 90b. In this way, the sump unit can be more easily installed on the post by placing the two halves 90a, 90b at either side of the post and then attaching them to each other. That may be achieved by using a fastening means to pull the two halves together. However, other methods may be used. A strap may be wrapped around the outer periphery of the two halves and then tightened to clamp the two halves together. One end of the two halves may be hinged together so that the unit can be opened using the hinge placed around the post and then closed again and attached together at the opposite to the hinge.

The diameter of the central recess 718, 718a, 718b may be arranged to be slightly smaller than the lamp post or packed with a resilient material or the like such that as the two halves are pulled towards each other, they engage and clamp onto the upright post of the lamp post like a collar. Other means of holding the device in place up the post may be used such as a supporting collar beneath the sump unit 71, 90a, 90b to provide vertical support.

The sump unit 71 is again a laminar structure with an upper base unit at the top and a sump body (not shown) underneath. Where the sump unit 71 is formed in two halves, the sump body may also be divided into two parts.

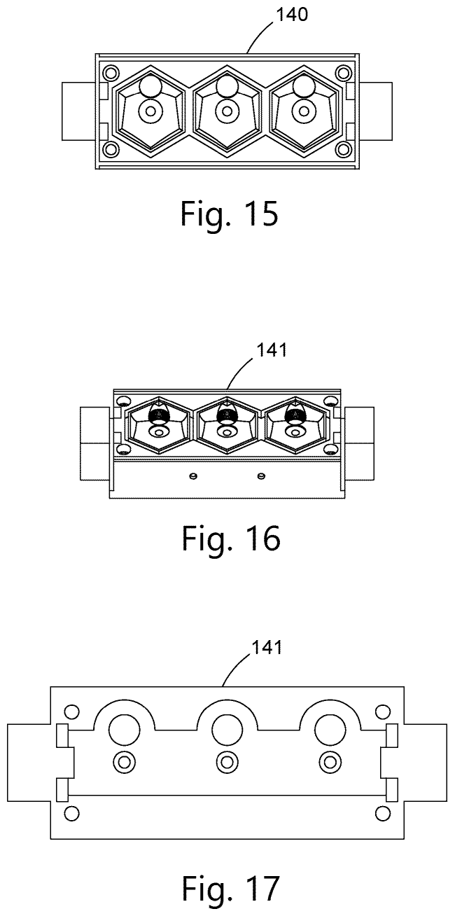

FIGS. 15 to 17 show a further embodiment, in which a much smaller unit is provided with a reduced number of tubes. Again, the general structure is similar to the other two arrangements described above but in a smaller format. The example in FIG. 14 shows the sump unit 140. The structure has a similar laminar arrangement with a sump base unit 141 on top of a sump body and sump base at the bottom. FIG. 16 shows a perspective view of the sump base unit 141. FIG. 17 shows a view of the sump base unit 141 from below. A corresponding cover unit would also be provided. It is generally more preferable to have larger numbers of tubes to achieve efficiency of scale but small units might have utility in a modular system. These smaller units may be used in conjunction with larger units or for small scale, perhaps domestic use.

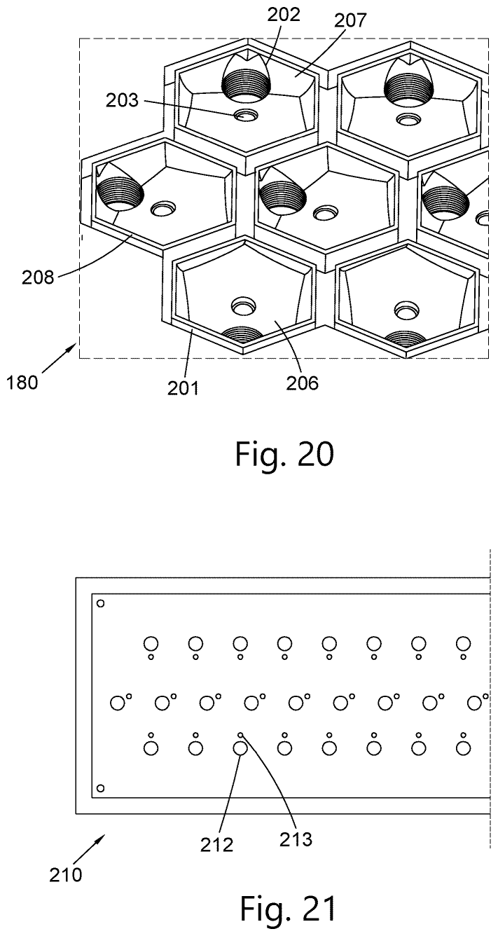

As noted below, the single layer structure may be modified into a multi-layer structure, such as that shown in FIGS. 18 to 22. With this arrangement, several layers of tubes may be set out abutting each other as shown in FIG. 18. Figure shows the sump unit 180 of the modified design. FIG. 19 shows a closer view of one end of the ump unit 180. FIG. 20 shows a similar view but in perspective. The sump unit has similar parts to those in the previous embodiments. The sump unit 180 includes the hexagonal receiving channels 201 into which the tubes are inserted. Within the inner wall 208 are side faces 207 arranged around the lower face 206. An exit hole 202 is provided to allow draining of the fluid in the tubes and a feed hole 203 allows gas to be passed into the tube.

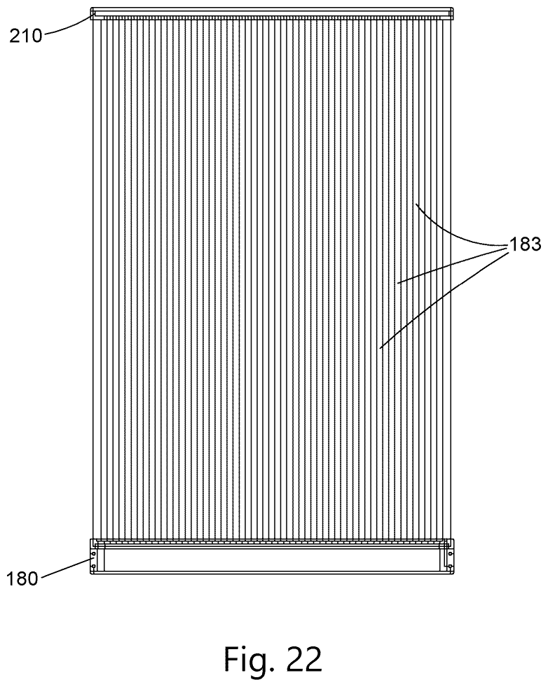

The cover unit 210 which is placed above the tubes. FIG. 21 shows the view from above where the exit hole 212 is provided to allow the gases emerging from the fluid to escape and a feed hole 213 which can be used to feed fluid into the tubes. FIG. 22 shows a side view of the structure with the tubes 183 in place between the sump unit 180 and the cover unit 210. The cover unit 210 and the sump unit 180 may have a similar layer structure to the cover unit 12 and the sump unit 11 described above.

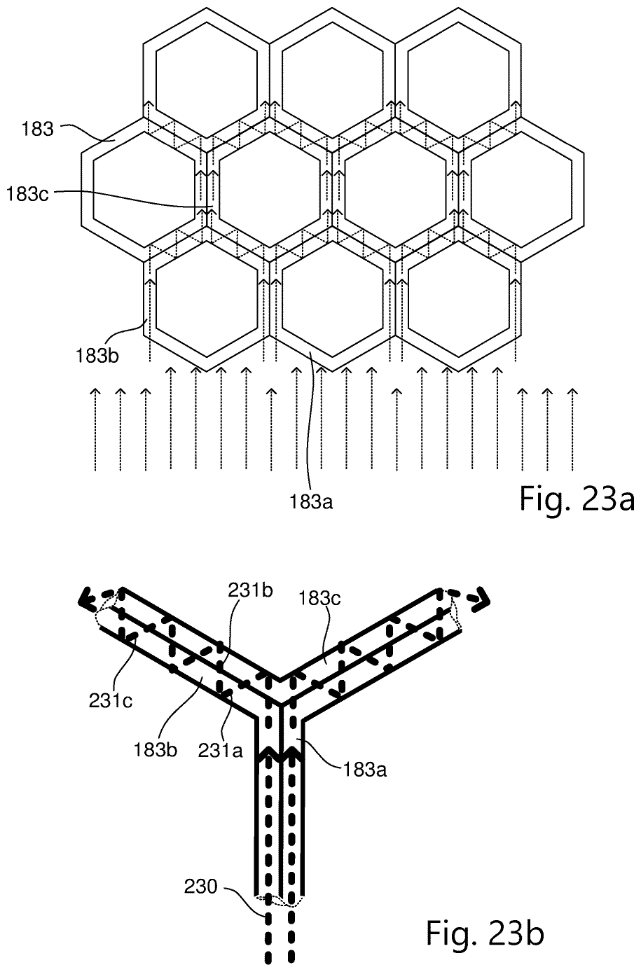

The tubes are arranged in the compact honeycomb structure which is efficient with space. In this example. There are shown three layers of tubes but additional layers may be provided. The tubes in the middle row(s) are isolated from direct light (unless light is artificially introduced into the middle row(s)-see below) unlike the outer layers of tubes. Whilst this may restrict the light reaching the inner layers of tubes, the angling of the walls resulting from the hexagonal structure means that light can penetrate the outer layers in particular passing along the walls of the tubes into the interior layers. The tubes are formed of material which is able to carry the light from the front of the tubes on the outer layer of tubes to the rear of those tubes to allow light to penetrate the layers within. FIG. 23a shows schematically how the light passing along pairs of adjacent tube walls is reflected and diffracted at the junctions to pass the light on to the next tube wall and into the interior where it can permeate into the fluid within the tubes.

The angles of the walls in a hexagonal structure means that the light passing along the walls of the front row of tubes reflects off the walls of the inner tube at an angle that will cause it to repeatedly reflect of the walls after the next intersection and then revert to the original direction after reflection on the next wall. As shown in FIG. 23b, and initial ray of light 230 passing along the first pair of walls of the respective tubes 230a, 230b, hits the inner surface of the tube 183c in the inner layer. The ray reflects as ray 231a which then reflects of the surface of the outer tube 183b and again travels as ray 231b in a similar direction to the original ray 230. Each subsequent reflection causes the rays to switch between the two directions until the ray reaches the point where the wall of the tube turns a corner and the ray then does not hit the wall of the inner tube 183c and instead carries up along the side wall of the tube 183c, as shown in FIG. 23a.

The multiple reflections off the surface of the tube walls tend to distribute the light throughout the structure. Each reflection will cause some light to pass through the wall and some to be reflected. By providing the multiple reflections but also directing the light through the structure, light is distributed effectively throughout. In this way, the light entering the front row of tubes can be carried to the walls of the inner tubes efficiently.

Whilst the outer rows of tubes will receive more incident light than the inner tubes, where the device is in a normal outdoor environment, the illumination will tend to be stronger one side than on the other due to the incident light coming from the sun. This will also vary throughout the day. Depending on how the device is oriented morning sun will impinge on one side and on the other side later in the day. As a result, the incident light on one side may be significantly stronger than on the other. The advantageous distribution of light through the device helps to distribute light more evenly across the tubes of the device. For example, light falling on the bright side, i.e. that receiving direct sunlight, may pass through the front rows to illuminate the middle row but then also pass through to the outer row on the far side which may be significantly shaded and only receive indirect or diffuse light, helping to improve the overall light received by that outer row. In this way, light from one side can be distributed potentially through the entire device to tubes on the opposite side whilst illuminating the central layers of tubes.

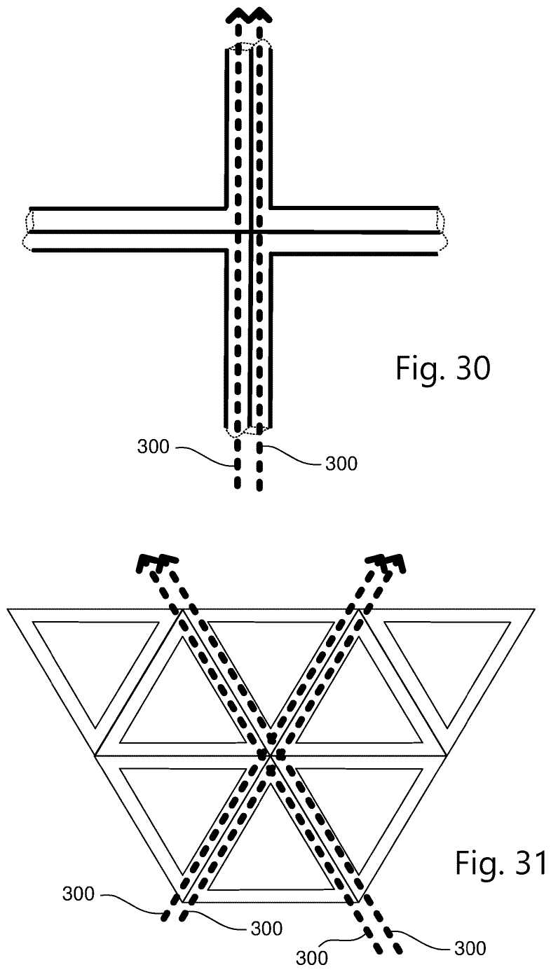

In contrast, where the tubes are square in cross-section, the rays 300 may pass straight through in a straight line along each wall. FIG. 30 shows schematically how a ray 300 of light entering the front of the device may simply pass through and out of the far side without impinging on the fluid within the tubes. Similarly for triangular tubes, light rays entering the front layer of tubes can pass along the tube walls in a straight direction potentially passing through the entire structure, as shown in FIG. 31. With the hexagonal tubes, there are no direct light paths though from one side to another and so light rays must reflect of the inner tube walls ensuring that a proportion of the light at each reflection is passed though into the fluid within.

This unique combination of compact packing and advantageous light distribution with hexagonal tubes ensures a better balance of light received by each tube whilst occupying the smallest footprint. Hexagonal tubes also provide a more robust and stronger structure to the device.

This multi-layer configuration can help to maximise the light utilisation such that light that may have passed straight through the tubes and fluid as well as via the tube walls is more likely to be captured. The multi-layer construction can also provide other benefits which may be helpful in other applications of the design. One advantage of these designs is that they can serve important secondary functions. The single layer design is efficient at capturing light but may also be useful in providing the function of a barrier or fence for example, next to a road or other boundary that needs to have a physical barrier. Such boundary are often expensive to erect and maintain and essentially provide no additional function. The arrangements described above can provide a secondary function of forming a barrier whilst operating to process gases.

In some instances, particularly next to roads, airport railways etc. it may be desirable to enhance the boundary to provide some level of noise abatement. Building secondary noise abatement structures next to a single layer structure may obstruct the light reaching the units. A single layered structure may not provide sufficient noise abating effect and/or have sufficient strength, especially where the boundary needs to be high. Therefore, the multilayer structure provides a significantly greater thickness to reduce noise whilst also enhancing the strength of the structure and so multi-layer units can provide improved noise abatement without requiring additional separate noise abatement structures.

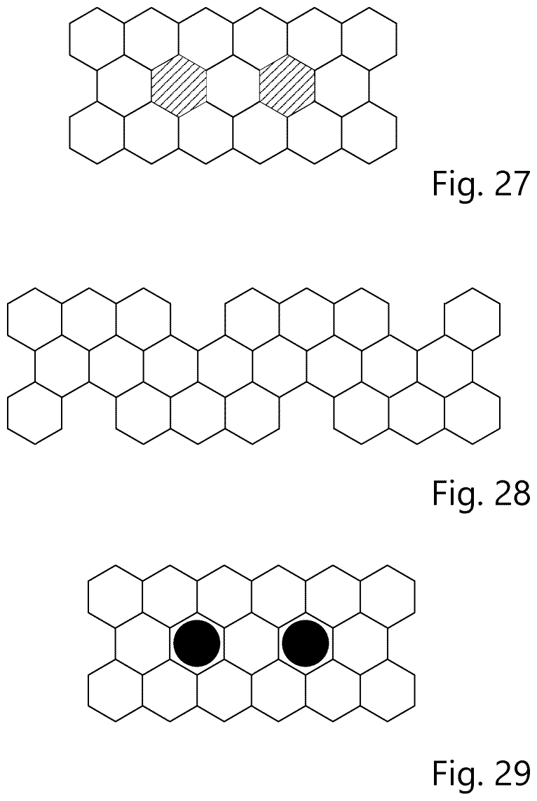

Modified structure may be used where some of the tubes are omitted. FIG. 27 shows a section of one such structure where periodic tube in the central layer of tubes are omitted. This can aid in light distribution through the device. Whilst the tubes may be omitted, the tubes may be retained but simply left empty. Other alternative may have absent or empty tubes on the outer layer, as shown in FIG. 28. This arrangement means that every tubes has at least one side facing direct light. This may enhance the light received by each tube including those in the central layer albeit at the expense of space efficiency. Other alternatives may include using the spaces occupied by some tubes to include lights or some kind of illumination. This might be inserting lights directly into the space which might be powered by solar power from panels located on or near the device. Alternatively, light may be channelled into the tubes from the top or bottom by using reflectors or light pipes to capture light that would otherwise not fall on the other tubes. This arrangement can again help to get additional light to the central layers.

As noted above, although the embodiment above shows three layers, there may be four or more layers. Such structures may have additional vacant tubes with or without additional light sources. It will be appreciated that the arrangements in FIGS. 27 to 29 and merely some examples of how tubes may be omitted or left empty to enhance light transmission to some tubes and other configurations may also be used. The design may be configured to factor in the position and orientation of the device to consider the direction and intensity of ambient light across each day and each year.

In the embodiments above, the tubes typically have of 50-100 mm between opposing faces. More preferably this will be between 60-80 mm. This provides a good balance between the distance that the light must pass through the fluid within the tubes whilst optimising the volume of fluid. Of course, different configurations may require different sizes. For example in the embodiment with multiple layers, the tubes may be smaller to reduce the distance the light must travel. Different consistencies of the fluid 14 used may also facilitate larger tubes sizes or require smaller ones depending on the transmissivity of the fluid (which will also vary over time).

The tubes are preferably completely filled and maintain in a state of being completely filled. This helps to avoid variations in the level leaving residue on the sides of the tubes as the level varies and algae on the surface dries out. It is typical for a foam or scum to develop on the upper surface of the fluid which may stick to the wall and then dry. This can impact the transmission of light passing through the tube walls. Such residue does not tend to form on the surface of the tubes beneath the surface of the fluid.

1. A carbon capture device comprising:
a sump unit having at least one gas inlet for receiving gas pumped into the sump and an upper surface, wherein a plurality of—gas outlets are provided on the upper surface of the sump unit;
a plurality of tubes mounted on the upper surface of the sump unit, each said tube having an upper end and a lower end and arranged to form a seal between the lower end of the tube and said upper surface, the tubes arranged to include a respective one of the plurality of gas outlets for providing gas to the interior of each tube;
a cover unit having a lower surface with a plurality of ports therein for receiving the upper ends of said plurality of tubes and arranged to receive gas from the plurality of tubes,
wherein the cover unit, the plurality of tubes and the sump unit are arranged to be secured together with the tubes retained between the lower surface of the cover unit and the upper surface of the sump unit . so that the assembly forms a barrier structure in which fluid can be retained within the tubes and in which said gas can pass upwardly through the fluid from the sump towards the cover unit.

2. A carbon capture device according to claim 1 wherein the tubes have a hexagonal profile.

3. (canceled)

4. A carbon capture device according to claim 1 wherein the tubes are arranged side by side in a linear pattern to form a layer of tubes.

5. A carbon capture device according to claim 1 wherein the tubes are arranged with a plurality of layers of tubes, each layer including a plurality of tubes arranged side by side in a linear pattern, with adjacent layers closely interlocked with each other.

6. A carbon capture device according to claim 1 wherein the sump unit has a central recess for mounting around a post, with the tubes arranged around the central recess.

7. A carbon capture device according to claim 6 where the sump unit is formed of a plurality of separable parts to allow installation of the sump around a post positioned in the central recess.

8. A carbon capture device according to claim 1 further comprising a gas supply for supplying gas to each of the gas outlets on the sump unit.

9. A carbon capture device according to claim 1 wherein the sump unit includes:
a base unit on which the tubes are mounted and including the gas outlets, each of which is connected to a corresponding receiving port on the base unit; and
a main body including interconnecting pipework for distributing gas to output ports on the main body, each corresponding to a receiving port, wherein the base unit and main body are separably connected to form the sump unit such that the output ports and receiving ports form a sealed connection between each other.

10. A carbon capture device according to claim 1 wherein the main body includes a sump plate separably mounted to the sump unit, the sump plate enclosing the lower part of the sump unit to enclose the internal space of the sump unit.

11. A carbon capture device according to claim 1 wherein the sump unit includes a fluid inlet corresponding to each of the tubes, for removing fluid from the tubes, each fluid inlet being connected to a fluid outlet on the sump unit for removing the fluid from the sump unit.

12. A carbon capture device according to claim 11 wherein the sump unit includes a surface defined by the profile of an adjacent one of said tubes, the surface having a lower face and one or more side faces for directing fluid contained in the tubes into a respective fluid inlet of the sump unit.

13. A carbon capture device according to claim 12 wherein the lower face is angled relative to the horizontal axis of the sump unit.

14. A carbon capture device according to claim 12 wherein the side faces are angled relative to the vertical axis of the sump unit.

15. A carbon capture device according to claim 14 wherein the side faces have a concave profile forming a fillet shape.
